(19) United States
(12) Patent Application Publication
(10) Pub. No.: US 2022/0261552 A1
(43) Pub. Date: Aug. 18, 2022

(54) SENTENCE COMPARISON DEVICE, SENTENCE COMPARISON METHOD, AND SENTENCE COMPARISON PROGRAM

(71) Applicant: NIPPON TELEGRAPH AND TELEPHONE CORPORATION, Tokyo (JP)

(72) Inventors: Takaaki TANAKA, Tokyo (JP); Masaaki NAGATA, Tokyo (JP); Yuki ARASE, Tokyo (JP)

(73) Assignee: NIPPON TELEGRAPH AND TELEPHONE CORPORATION, Tokyo (JP)

(21) Appl. No.: 17/627,628

(22) PCT Filed: Jul. 8, 2020
(86) PCT No.: PCT/JP2020/026744

§ 371 Date: Jan. 14, 2022

(30) Foreign Application Priority Data
Jul. 17, 2019 (JP) 2019-131583

(51) Int. Cl. G06F 40/30; G06F 40/253; G06F 40/211

(52) U.S. Cl. CPC G06F 40/30; G06F 40/211; G06F 40/253

(57) ABSTRACT

A language identification unit (101) identifies types of languages of each of multiple input sentences, which are described in natural language, described in different languages, a multilingual language analysis unit (102) analyzes the syntax structure of each of the input languages in accordance with the types of the languages, a multilingual semantic analysis unit (103) analyzes the semantic structure of each of the input sentences in accordance with the types of the languages, and a multilingual semantic representation comparison unit (104) compares the input sentences to each other based on the analysis results of the semantic structure, calculates a degree of similarity between the input sentences, and appropriately compares the input sentences of different languages to each other based on the degree of similarity calculated by capturing semantic contents of the representation of the input sentences which are text data.

### TECHNICAL FIELD

The disclosed techniques relate to a sentence comparison apparatus, a sentence comparison method, and a sentence comparison program.

### BACKGROUND ART

In natural language processing, measuring of the similarity of multiple different sentences (text data) is performed when performing, for example, evaluation of machine translation, scoring answers of descriptive test problems, detection of plagiarism of a thesis, and the like. In particular, in terms of quality evaluation of machine translation or scoring answers of descriptive test problems that deal with foreign language, it is necessary to measure similarity between sentences different in languages described. As a technique to measure similarity of sentences, there is a technique to calculate the degree of similarity between multiple input sentences based on, for example, the similarity of words or word sequences included in the input sentences (e.g., see NPL 1).

### CITATION LIST

### Non Patent Literature

NPL 1: Frane ▴S▾ari▴c▾, Goran Glava▴s▾, Mladen Karan, Jan ▴S▾najder and Bojana Dalbelo Ba▴s▾i▴c▾: TakeLab Systems for Measuring Semantic Text Similarity, In Proceedings of the First Joint Conference on Lexical and Computational Semantics, SemEval '12, pp. 441-448, (2012).

### SUMMARY OF THE INVENTION

### Technical Problem

However, in a method for comparing input sentences based on superficial information such as words and word sequences, it may be difficult to calculate the degree of similarity that properly captures semantic contents of the original input sentences between input sentences in which similar words and word sequences appear. Furthermore, in a case of measuring similarity between input sentences different in languages described, there is a high probability that structures of input sentences are greatly different, so it is further difficult to measure similarity of semantic contents.

For example, consider a case of measuring which of the two sentences: (1) “ [symbol] [symbol] [symbol] ” (symbols ‘/’ represent word delimiters); (2) “ [symbol] [symbol] [symbol] ” to be compared is semantically similar to the original sentence “The dog wearing a hat was running”. In a case of simply defining a ratio that words in the original sentence appear in the sentences to be compared as degree of similarity, using a translation-pair dictionary between English and Japanese, a similarity of matching the 7 words contained in the original sentence with the sentence of (1) is 4/7 as 4 words of (dog, [symbol] ), (wear, [symbol] ), (hat, [symbol] ), and (run, [symbol] ) appear, and a similarity of matching the original sentence with the sentence of (2) is 2/7 as two words of (hat, [symbol] ), and (run, [symbol] ) appear, resulting that the sentence of (1) is more similar to the original sentence.

This is because the degree of similarity cannot be appropriately calculated by not exactly capturing associations between two sentences that “dog” and “ [symbol] ” are words having similar semantic contents, the agent of “run” is “dog” as the semantic content that is common in the original sentence and the sentence of (2), the agent of “ [symbol] ” that is a concept similar to “run” is “ [symbol] ” that is a concept similar to “dog”, and associations between two sentences that the target with which “hat” accompanies is “dog” and the target with which “ [symbol] ” that is a concept similar to “hat” accompanies is “ [symbol] ” that is a concept similar to “dog”.

The present invention has been made in view of the foregoing, and an object of the present invention is to provide a sentence comparison apparatus, method, and program capable of appropriately comparing input sentences of different languages to each other based on a calculated degree of similarity by capturing semantic contents of the representation of the input sentences, which are text data.

### Means for Solving the Problem

A first aspect of the present disclosure is a sentence comparison apparatus including a multilingual semantic analysis unit configured to analyze, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences, and a multilingual semantic representation comparison unit configured to compare the input sentences to each other to calculate a degree of similarity between the input sentences based on an analysis result of the semantic structure by the multilingual semantic analysis unit.

A second aspect of the present disclosure is a sentence comparison method including analyzing, by a multilingual semantic analysis unit, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences, and comparing, by a multilingual semantic representation comparison unit, the input sentences to each other to calculate a degree of similarity between the input sentences based on an analysis result of the semantic structure by the multilingual semantic analysis unit.

A third aspect of the present disclosure is a sentence comparison program for causing a computer to operate as a multilingual semantic analysis unit configured to analyze, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences, and a multilingual semantic representation comparison unit configured to compare the input sentences to each other to calculate a degree of similarity between the input sentences based on an analysis result of the semantic structure by the multilingual semantic analysis unit.

### Effects of the Invention

According to the disclosed techniques, input sentences of different languages can be appropriately compared to each other based on the degree of similarity calculated by capturing semantic contents of the representation of the input sentences which are text data.

### BRIEF DESCRIPTION OF DRAWINGS

FIG. 1 is a block diagram illustrating a hardware configuration of a sentence comparison apparatus according to the present embodiment.

FIG. 2 is a functional block diagram of a sentence comparison apparatus according to the present embodiment.

FIG. 3 is a diagram illustrating an example of syntax analysis results of input sentences S₁ and S₂.

FIG. 4 is a diagram illustrating an example of semantic analysis results of the input sentences S₁ and S₂.

FIG. 5 is a diagram illustrating an example of semantic tuples.

FIG. 6 is a diagram illustrating an example of alignment results and degree of similarity calculation.

FIG. 7 is a flowchart illustrating an example of sentence comparison processing routine according to the present embodiment.

FIG. 8 is a diagram illustrating another example of semantic analysis results of the input sentences S₁ and S₂.

### DESCRIPTION OF EMBODIMENTS

Hereinafter, one example of the embodiments of the disclosed technique will be described with reference to the drawings. In the drawings, the same reference numerals are given to the same or equivalent constituent elements and parts.

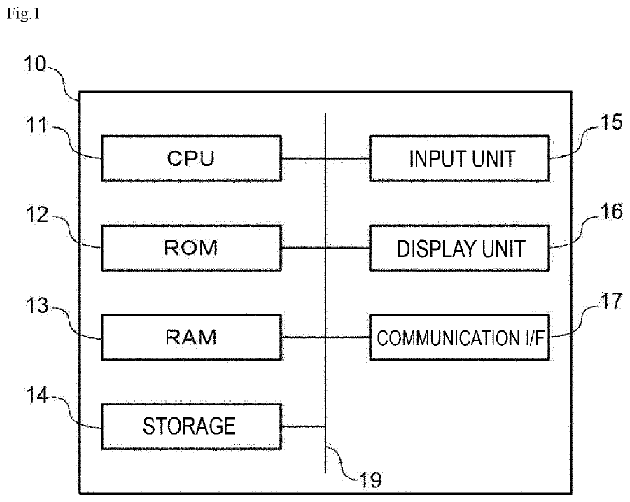

FIG. 1 is a block diagram illustrating a hardware configuration of a sentence comparison apparatus 10.

As illustrated in FIG. 1, the sentence comparison apparatus 10 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, a sentence comparison program for executing the sentence comparison processing described below is stored in the ROM 12 or the storage 14.

The ROM 12 stores various programs and various kinds of data. The RAM 13 is a work area that temporarily stores a program or data. The storage 14 is constituted by a hard disk drive (HDD) or a solid state drive (SSD) and stores various programs including an operating system and various kinds of data.

The input unit 15 includes a pointing device such as a mouse and a keyboard and is used for performing various inputs.

The display unit 16 is, for example, a liquid crystal display and displays various kinds of information. The display unit 16 may employ a touch panel system and function as the input unit 15.

The communication I/F 17 is an interface for communicating with other devices and, for example, uses a standard such as Ethernet (trade name), FDDI, or Wi-Fi (trade name).

Next, a functional configuration of the sentence comparison apparatus 10 will be described.

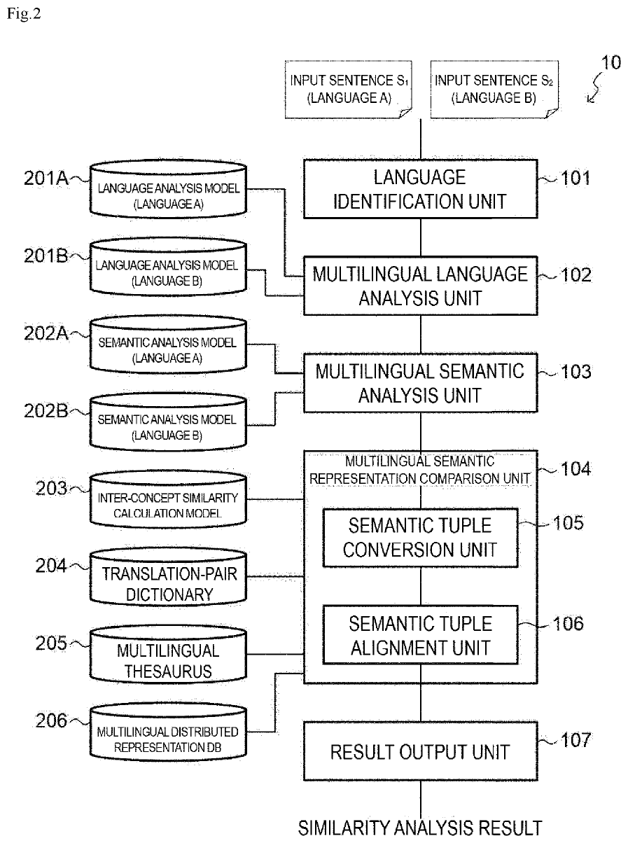

FIG. 2 is a block diagram illustrating an example of the functional configuration of the sentence comparison apparatus 10.

As illustrated in FIG. 2, the sentence comparison apparatus 10 includes a language identification unit 101, a multilingual language analysis unit 102, a multilingual semantic analysis unit 103, a multilingual semantic representation comparison unit 104, and a result output unit 107, as functional components. A predetermined storage area of the sentence comparison apparatus 10 stores language analysis models 201A and 201B, semantic analysis models 202A and 202B, an inter-concept similarity calculation model 203, a translation-pair dictionary 204, a multilingual thesaurus 205, and a multilingual distributed representation database (DB) 206. Each functional component is implemented by the CPU 11 reading a sentence comparison program stored in the ROM 12 or the storage 14, and loading the sentence comparison program in the RAM 13 to execute the program.

The language identification unit 101 receives a sentence (text data) described in a natural language, which is input to the sentence comparison apparatus 10 (hereinafter referred to as an “input sentence”). In the following, a case in which an input sentence S₁ in English “The dog wearing a hat was running.” and an input sentence S₂ in Japanese “ [symbol] [symbol] ” are input as the input sentences will be described as an example.

The language identification unit 101 identifies the type of language described for each of the received input sentences. Identification of the type of language may be performed, for example, by estimating the character codes or the like used, as performed in a web browser, or may be provided explicitly as metadata to the input sentences. Here, the language identification unit 101 identifies the language of the input sentence S₁ as English and the language of the input sentence S₂ as Japanese, and passes the input sentences and the identification result of the types of language of the input sentences to the multilingual language analysis unit 102.

The multilingual language analysis unit 102 performs linguistic analysis such as syntax analysis on the input sentences received from the language identification unit 101 using the language analysis model 201A for the language A and the language analysis model 201B for the language B (reference literature 1), and passes the syntax analysis results to the multilingual semantic analysis unit 103. Note that, in the present embodiment, a case in which the multilingual language analysis unit 102 uses the rules of Universal Dependencies (reference literature 2) as the syntax structure used for analysis will be described. In this case, information required for analysis in accordance with the rules of Universal Dependencies is defined for the language analysis models 201A and 201B.

Note that while the method of syntax analysis used for analysis by the multilingual language analysis unit 102 is preferably performed based on a specification that is common among languages as in Universal Dependencies; however, it is sufficient that the multilingual semantic analysis unit 103 described below can convert the language into a comparable semantic representation, and other syntax analysis methods may be used.

Reference literature 1: Joakim Nivre et al.: MaltParser: A language-independent system for data-driven dependency parsing, Natural Language Engineering, 13 (2), pp. 95 {135 (2007). Reference literature 2: Joakim Nivre: Towards a Universal Grammar for Natural Language Processing, In Proceedings of CICLing 2015, pp. 3-16, (2015).

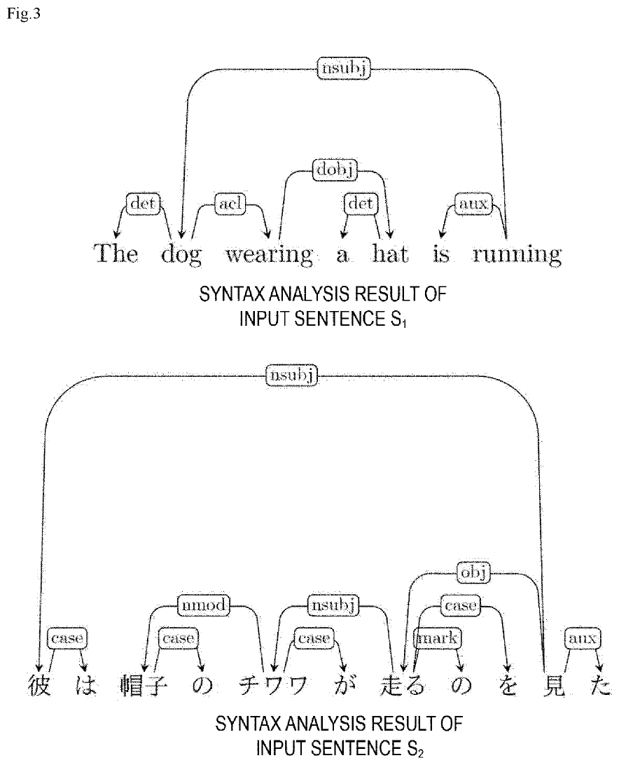

FIG. 3 illustrates an example of syntax analysis results in which the input sentences S₁ and S₂ are analyzed in accordance with the rules of Universal Dependencies, which is a specification of syntax analysis that is common in multiple languages. In Universal Dependencies, analysis directed to different languages can be performed in the same syntax analyzer, but a different language analysis model is used for each language of interest, such as the language analysis model 201A of English (Language A) for the input sentence S₁ and the language analysis model 201B of Japanese (language B) for the input sentence S₂. In the syntax analysis results illustrated in FIG. 3, two words having a grammatical dependency are tied by an arrow, where the word of the root of the arrow indicates the head, and the word of the tip of the arrow indicates the dependent. The labels attached to the arrows (in FIG. 3, indicated by rounded squares) indicate the types of relationships between the two words tied by the arrows.

For example, in the syntax analysis results of the input sentence S₁ illustrated in the top view of FIG. 3, “dog←(nsubj)—running” indicates that there is a subject-predicate relationship nsubj between “dog” and “running”, and “running” is the head. Similarly, in the syntax analysis results of the input sentence S₂ illustrated in the bottom view of FIG. 3, “ [symbol] ←nsubj— [symbol] ” indicates that there is a subject-predicate relationship nsubj between “ [symbol] ” and “ [symbol] , and “ [symbol] ” is the head.

The multilingual semantic analysis unit 103 receives the syntax analysis results from the multilingual language analysis unit 102, analyzes the semantic structures of the input sentences by using the semantic analysis models 202A and 202B, and passes the semantic analysis results where the syntax analysis results are converted to semantic representations to the multilingual semantic representation comparison unit 104. Note that, in the present embodiment, a case in which the multilingual semantic analysis unit 103 uses the rules of UDepLambda (reference literature 3) as semantic representations will be described. In this case, information required for analysis in accordance with the rules of UDepLambda is defined for the semantic analysis models 202A and 202B. Note that the semantic representations used for analysis by the multilingual semantic analysis unit 103 are not limited to the examples described above, and rules of other semantic representations such as semantic representations of a semantic graph type such as Abstract Meaning Representation (AMR, reference literature 4) may be used.

Reference literature 3: Siva Reddy, Oscar Tackstrom, Slav Petrov, Mark Steedman and Mirella Lapata: Universal Semantic Parsing, In Proceedings of the Conference on Empirical Methods in Natural Language Processing, EMNLP 2017, (2017).
Reference literature 4: Laura Banarescu, Claire Bonial, Shu Cai, Madalina Georgescu, Kira Griffin, Ulf Hermjakob, Kevin Knight, Philipp Koehn, Martha Palmer and Nathan Schneider: Abstract Meaning Representation for Sembanking, In Proceedings of the Linguistic Annotation Workshop, (2013).

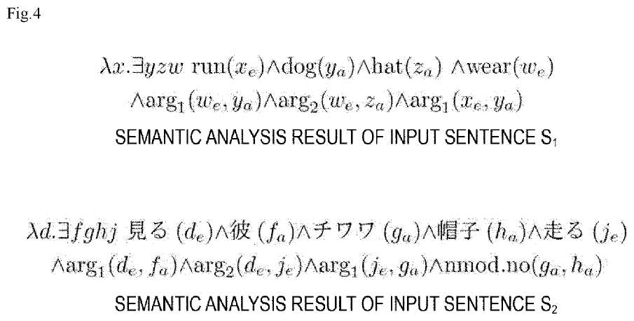

FIG. 4 illustrates an example of semantic analysis results obtained by analyzing the input sentences S₁ and S₂ in accordance with the rules of UDepLambda. The semantic analysis results illustrated in FIG. 4 are semantic representations of a predicate logical format type in accordance with the rules of UDepLambda, and include variables that indicate individuals or events, and functions. The subscript a indicates that the type of variable is an individual, and the subscript e indicates that the type of variable is an event, as in yₐ and xₑ. Similar to the multilingual semantic analysis unit 103, a same semantic analyzer performs analysis using a semantic analysis model corresponding to each language of interest such as the semantic analysis model 202A of English (language A) for the input sentence S₁ and the semantic analysis model 202B of Japanese (language B) for the input sentence S₂. Note that, in the semantic representations of the predicate logical format type in the present embodiment, among words included in the input sentences, a word having a concept in itself (hereinafter, also simply referred to as a “concept”) is treated as a variable.

In the semantic analysis result of the input sentence S₁ illustrated in FIG. 4, the variable x denoted by λx represents the major predicate of the sentence, and variables y, z, and w represent other variables. A single-term logical formula (e.g., “run (xₑ)”) indicates association of concept and variable. For example, run (xₑ) indicates that the concept “run” is represented by the variable “xₑ”. A two-term function (e.g., “arg₁ (xₑ, yₐ)”) indicates a relationship between concepts represented by variables. For example, arg₁ (xₑ, yₐ) indicates that the individual (dog) represented by the variable “yₐ” is the agent of the event (run) represented by the variable “xₑ”.

The multilingual semantic representation comparison unit 104 performs association between semantic structures between the input sentences based on the translation-pair dictionary 204, the multilingual thesaurus 205, and the multilingual distributed representation DB 206, using the semantic representations that are the semantic analysis results received from the multilingual semantic analysis unit 103. In the multilingual distributed representation DB 206, associations of distributed representations of words between multiple languages are stored. The multilingual semantic representation comparison unit 104 uses the inter-concept similarity calculation model 203 to calculate degree of similarity between input sentences based on the associations between semantic structures. As illustrated in FIG. 2, the multilingual semantic representation comparison unit 104 includes a semantic tuple conversion unit 105 and a semantic tuple alignment unit 106.

The semantic tuple conversion unit 105 converts the semantic representation received from the multilingual semantic analysis unit 103 into a semantic tuple. The semantic tuple includes “rel (variable₁, variable₂)” and “inst (variable, concept)”. The former semantic tuple represents that the relationship between the two variables is the relationship indicated by a label “rel”, and the latter semantic tuple represents the association between the variable and the concept in the input sentence (such as an individual or an event). For example, inst (x, run) indicates that the variable “x” belongs to the concept of “run”, and inst (y, dog) indicates that the variable “y” belongs to the concept of “dog”. Further, arg₁ (x, y) indicates that the concept of “dog” belonging to the variable “y” is the agent of the concept of “run” belonging to the variable “x”.

Specifically, the semantic tuple conversion unit 105 extracts sets V₁ and V₂ of variables, as illustrated in Equations (1) and (2) below, from the semantic representations of each of the input sentences S₁ and S₂ received from the multilingual semantic analysis unit 103, respectively.

V₁={v₁₁,v₁₂,v₁₃,v₁₄}={x,y,z,w} (1)

V₂={v₂₁,v₂₂,v₂₃,v₂₄,v₂₅56 ={d,f,g,h,j} (2)

Note that vᵢⱼ indicates the j-th variable in the input sentence Sᵢ.

The semantic tuple conversion unit 105 creates a semantic tuple in the form of inst (variable, concept) from a single-term logical formula included in a semantic representation of each of the input sentences S₁ and S₂ for each of the sets V₁ and V₂ of variables, and adds the semantic tuples to semantic tuple sets T₁ and T₂, as illustrated in the following Equations (3) and (4).

T₁={t₁₁,t₁₂,t₁₃,t₁₄}={inst (x, run), inst (y, dog), inst (z, hat), inst (w, wear)} (3)

T₂={t₂₁,t₂₂,t₂₃,t₂₄, t₂₅}={inst (d, [symbol] ), inst (f, [symbol] ), inst (g, [symbol] ), inst (h, [symbol] ), inst (j, [symbol] )} (4)

Note that tᵢⱼ indicates the j-th semantic tuple of the input sentence Sᵢ.

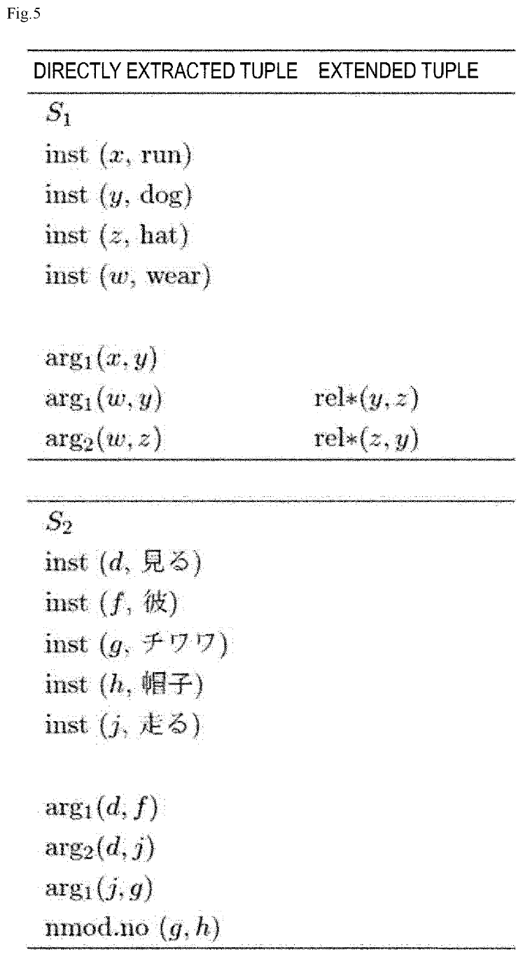

The semantic tuple conversion unit 105 creates a semantic tuple in the form of rel (variable₁, variable₂) from the two-term function included in a semantic representation of each of the input sentences S₁ and S₂, and adds the semantic tuples to the semantic tuple sets T₁ and T₂. The semantic tuple sets T₁ and T₂ after adding semantic tuples in the form of rel (variable₁ , variable₂) are illustrated in the “directly extracted tuple” column of FIG. 5.

By means of the above semantic tuples alone, the association between the relationship including the content word and the relationship via the adjunct word cannot be performed directly. Thus, the semantic tuple conversion unit 105 adds a new semantic tuple by combining semantic tuples having a common label (excluding subscripts) and a common variable in the first term. Specifically, the semantic tuple conversion unit 105 creates and adds new semantic tuples rel* (b, c) and rel* (c, b) from two semantic tuples, such as r₁ (a, b) and r₂ (a, c) as extended semantic tuples. Here, the labels arg₁ and arg₂ in FIG. 5 indicate that the second term corresponds to the agent or target of the first term, respectively. The label “rel*” indicating a relationship of variables in these extended semantic tuples is a label indicating that it can be associated with any other label during alignment (association) of a semantic tuple described below. The extended semantic tuples are illustrated on the right side of FIG. 5. These extended semantic tuples are added to the semantic tuple set T₁.

The semantic tuple conversion unit 105 passes the converted and added semantic tuples to the semantic tuple alignment unit 106.

The semantic tuple alignment unit 106 seeks optimal alignment between semantic tuples for each of the input sentences S₁ and S₂ received from the semantic tuple conversion unit 105. In the present embodiment, a case in which the alignment is easily performed with a low computational amount by heuristic search such as a hill climbing method will be described, but it is also possible to solve the strict solution by a method such as an integer linear programming (ILP).

Specifically, the semantic tuple alignment unit 106 configures an initial alignment row between the sets of variables extracted by the semantic tuple conversion unit 105. Consider a one-to-one alignment from V₁ to V₂ when |V₁|≤|V₂|. When there is an alignment in (t₁ᵢ, t₂ⱼ), aᵢ is represented as aᵢ=j and the alignment row from V₁ to V₂ is represented as A=(a₁, . . . , aₘ) (where m=|V₁|). When there is no alignment corresponding to t₁ᵢ, aᵢ=0. Here, the semantic tuple alignment unit 106 configures the initial alignment row A₀ as illustrated in Equation (5) below.

A₀=(1, 2, 3, 4) (5)

This indicates that the sets of variables (x, d), (y, f), (z, g), and (w, h) are aligned.

The semantic tuple alignment unit 106 calculates a configured alignment score (hereinafter referred to as an “alignment score”) σ_{align} in the semantic tuple sets T₁ and T₂, according to the following Equation (6).

$$\begin{matrix}[ Math . 1 ] & \\ {σ}_{align} = \frac{2 \cdot {\sum }_{{i}_{1}} ∈ {T}_{1} \text{?} {t}_{2} ∈ {T}_{2} σ T ( {t}_{1} \cdot {t}_{2} )}{\vert {T}_{1} \vert + \vert {T}_{2} \vert} \\ & ( 6 )\end{matrix}$$

$$\text{?} \text{indicates text missing or illegible when filed}$$

Here, the semantic tuples t₁i (∈T₁) and t₂j (∈T₂) are defined as t₁ᵢ=r₁ (h₁ᵢ, d₁ᵢ) and t₂ⱼ=r₂ (h₂ⱼ, d₂ⱼ), and the degree of similarity σ_{T} (t₁ᵢ, t₂ⱼ) between the semantic tuples t₁ᵢ and t₂ⱼ are defined as in the following Equations (7) to (9).

$$\begin{matrix}[ Math . 2 ] & \\ {σ}_{T} ( {t}_{1 i ,} {t}_{2 j} ) = \text{?} & ( 7 )\end{matrix}$$

$$\text{?} = \{ \begin{matrix}1 & when {r}_{1} = {r}_{2} or {r}_{1} = {rel}^{*} or {r}_{2} = {rel}^{*} \\ 0 & other cases\end{matrix} \qquad ( 8 )$$

$$\text{?} = \{ \begin{matrix}1 & {v}_{1} and {v}_{2} are concepts \\ \text{?} & {v}_{1} and {v}_{2} are concepts \\ 0 & other cases\end{matrix} \qquad ( 9 )$$

$$\text{?} \text{indicates text missing or illegible when filed}$$

Note that in Equation (7), “h” denotes the initial character of head, and “d” denotes the initial character of dependent, and each indicates the first term and the second term of the semantic tuple, respectively. Note that in Equation (7), “h” with subscripts indicates a label for a semantic tuple, and is different from “h” without a subscript, which is an element of V₂ represented by Equation (2). In Equation (9), I (·) is a mapping to a concept that is associated with a variable, e.g., in an example of the semantic analysis result of the input sentence S₁, I (x)=run. Although sim_{con} (·, ·) is a degree of similarity between concepts, it is necessary to measure the degree of similarity of the concepts across the languages because the languages between the first term and the second terms are different. To compare concepts across languages, an ontology defined in multiple languages, such as the translation-pair dictionary 204 and WordNet (reference literature 5), or word distributed representations that are constructed in a single space between multiple languages, such as fastText multilingual (reference literature 6) or facebook (trade name) Muse (reference literatures 7 and 8), can be used.

Reference literature 5: George A. Miller, WordNet: A Lexical Database for English, COMMUNICATIONS OF THE ACM, Vol 38, pp. 39-41, (1995).
Reference literature 6: Samuel L. Smith and David H. P. Turban and Steven Hamblin and Nils Y. Hammerla, Offline bilingual word vectors, orthogonal transformations and the inverted softmax. In Proceedings of the 5th International Conference on Learning Representations, ICLR 2017, (2017).
Reference literature 7: Alexis Conneau, Guillaume Lample, MarcAurelio Ranzato, Ludovic Denoyer, and Herve Jegou., Word translation without parallel data. arXiv preprint arXiv: 1710.04087, (2017).
Reference literature 8: Guillaume Lample, Alexis Conneau, Ludovic Denoyer, and MarcAurelio Ranzato., Unsupervised machine translation using monolingual corpora only., arXiv preprint arXiv: 1711.00043, (2017).

In the present embodiment, it is assumed that the degree of similarity is a real number from 0 to 1, and when the degree of similarity is 1, the semantic contents represented by the partial structures of the semantic representations of the comparison subjects are completely matched. For example, the semantic tuple alignment unit 106 uses the inter-concept similarity calculation model 203 in which an correspondence between a concept and a vector in which the concept has been converted into a distributed representation of words is defined, to calculate the degree of similarity sim_{con} (c₁,c₂) between concepts as illustrated in Equation (10) below. The degree of similarity sim_{con} (c₁,c₂) is represented by whether the concepts c₁ and c₂ are present in the translation-pair dictionary 204 as a parallel translation pair, and the cosine distance between the vectors v_{c1} and v_{c2} in the case of converting the concepts c₁ and c₂ represented in different languages into the vectors v_{c1} and v_{c2} of word distributed representations in the same space, respectively.

$$\begin{matrix}[ Math . 3 ] & \\ \text{?} = \{ \begin{matrix}1 & \begin{matrix}concepts {c}_{1} and {c}_{2} are present in \\ translation ‐ pair dictionary\end{matrix} \\ cos \text{?} & other cases\end{matrix} & ( 10 )\end{matrix} \\ \text{?} \text{indicates text missing or illegible when filed}$$

Further, α(·, ·) is a function representing the presence or absence of alignment as illustrated in Equation (11) below.

$$\begin{matrix}[ Math . 4 ] & \\ \text{?} = \{ \begin{matrix}1 & \begin{matrix}\begin{matrix}( \begin{matrix}{v}_{1} and {v}_{2} are variables and \\ both variables are aligned\end{matrix} ) , or \\ {v}_{1} and {v}_{2} are concepts\end{matrix} \\ translation ‐ pair dictionary\end{matrix} \\ 0 & other cases\end{matrix} & ( 11 )\end{matrix} \\ \text{?} \text{indicates text missing or illegible when filed}$$

The semantic tuple alignment unit 106 calculates the alignment score σ_{align} (A₀) for the initial alignment row A₀ according to Equations (6) to (11). |T₁|+T₂|, i.e., the number of semantic tuples obtained from the semantic representations of the input sentences S₁ and S₂ is 18 including the directly extracted tuples and the extended tuples. For a combination of semantic tuples including unaligned variables, α(·, ·)=0, so in a case that σ_{T} (·, ·) having a combination of any of combinations of aligned variables (x, d), (y, f), (z, g), and (w, h) as arguments is specified, σ_{align} (A₀) is calculated as in the following Equation (12). Here, in a case that all of sim_{con} (run, [symbol] ), sim_{con} (dog, [symbol] ), sim_{con} (hat, [symbol] ), and sim_{con} (wear, [symbol] ) is 0, as the result, σ_{align} (A₀)=0.

$$\begin{matrix}[ Math . 5 ] & \\ \begin{matrix}{σ}_{align} ( {A}_{0} ) = 2 \cdot ( \sum \text{?} ( {t}_{1} , {t}_{2} ) ) / 18 \\ = 2 \cdot ( {σ}_{T} ( inst ( x , run ) , inst ( d , ) ) \\ + {σ}_{T} ( inst ( y , dog ) , inst ( f , ) ) \\ + {σ}_{T} ( inst ( z , hat ) , inst ( g , ) ) \\ + {σ}_{T} ( inst ( w , wear ) , inst ( h , ) ) ) / 18 \\ = 2 \cdot ( 0 + 0 + 0 + 0 ) / 18 = 0\end{matrix} & ( 12 )\end{matrix} \\ \text{?} \text{indicates text missing or illegible when filed}$$

The semantic tuple alignment unit 106 changes the alignment with as few operations as possible from the initial alignment row A₀ to generate an alignment row candidate set Q. In other words, the alignment row candidate set Q is generated as illustrated in the following Equation (13) as candidates for the optimal alignment row, either by performing an operation for associating one variable with other variables with respect to the initial alignment row A₀ or performing an operation for replacing the association between two alignments.

Q={(1, 2, 3, 5), (1, 2, 5, 4), (1, 5, 3, 4), (5, 2, 3, 4), (2, 1, 3, 4), (1, 3, 2, 4), (1, 2, 4, 3), (4, 2, 3, 1), (3, 2, 1, 4), (1, 4, 3, 2)} (13)

The semantic tuple alignment unit 106 calculates the alignment score for each alignment row candidate included in the alignment row candidate set Q, and determines the alignment row candidate with the highest alignment score. Specifically, the semantic tuple alignment unit 106 selects one alignment row candidate from the alignment row candidate set Q and calculates the alignment score. For example, in a case that an alignment row candidate A₁=(1, 2, 4, 3) is selected, the alignment score σ_{align} (A₁) is calculated as in the following Equation (14). Here, simᵥₐᵣ (I (z), I (h)) represents the degree of similarity between the concept “hat” of English associated with the variable z and the concept “ [symbol] ” of Japanese associated with the variable h, and both concepts are associated with each other in the translation-pair dictionary 204, so the value is 1 according to Equation (10).

$$\begin{matrix}[ Math . 6 ] & \\ \begin{matrix}{σ}_{align} ( {A}_{1} ) = 2 \cdot ( {σ}_{T} ( inst ( x , run ) , inst ( d , ) ) \\ + {σ}_{T} ( inst ( y , dog ) , inst ( f , ) ) \\ + {σ}_{T} ( inst ( z , hat ) , inst ( h , ) ) \\ + {σ}_{T} ( inst ( w , wear ) , inst ( g , ) ) ) / 18 \\ = 2 \cdot ( \text{?} ( inst , ) \text{?} ) \cdot \text{?} ( I ( x ) , I ( d ) ) \\ + \text{?} ( inst , inst ) \cdot \text{?} ( I ( y ) , I ( f ) ) \\ + \text{?} ( inst , inst ) \cdot \text{?} ( I ( z ) , I ( h ) ) \\ + \text{?} ( inst , inst ) \cdot \text{?} ( I ( w ) , I ( g ) ) ) / 18 \\ = 2 \cdot ( 0 + 0 + 1 + 0 ) / 18 = 0.111\end{matrix} & ( 14 )\end{matrix} \\ \text{?} \text{indicates text missing or illegible when filed}$$

Because σ_{align} (A₁) illustrated in Equation (14) is higher than the original alignment score σ_{align} (A₀), the semantic tuple alignment unit 106 configures the alignment row candidate A₁ as the next alignment row. The semantic tuple alignment unit 106 removes the original alignment row A₀ from the alignment row candidate set Q and adds the original alignment row A₀ to an alignment row candidate set C where the alignment scores have been calculated. The semantic tuple alignment unit 106 repeats this processing until there is no longer alignment row candidates with higher alignment scores than the original alignment row, i.e., until all alignment row candidates are added to the alignment row candidate set C. In a case of the alignment row candidate set Q illustrated in Equation (13) and an alignment row Aₙ=(5, 3, 4, 1), the alignment score is maximized, as illustrated in the following Equations (15) and (16). Here, in Equation (15), because x and j, y and g are aligned between arg₁ (x, y) and arg₁ (j, g), α(·, ·)=1, and the term of σ_{T} (arg₁ (x, y), arg₁ (j, g)) remains without being 0. Similarly, because y and g, z and h are aligned between rel* (y, z) and nmod.no (g, h), there remains a term of σ_{T} (rel* (y, z), nmod.no (g, h)).

$$\begin{matrix}[ Math . 7 ] & \\ \begin{matrix}{σ}_{align} ( {A}_{1} ) = 2 \cdot ( \sum \text{?} ( {t}_{1} , {t}_{2} ) ) / 18 \\ = 2 \cdot ( {σ}_{T} ( inst ( x , run ) , inst ( j , ) ) \\ + {σ}_{T} ( inst ( \text{?} , dog ) , inst ( g , ) ) \\ + {σ}_{T} ( inst ( z , hat ) , inst ( h , ) ) \\ + {σ}_{T} ( inst ( w , wear ) , inst ( d , ) ) \\ + {σ}_{T} ( {arg}_{1} ( x , y ) , {arg}_{1} ( \text{?} ) ) \\ + {σ}_{T} ( rel \text{?} ( y , z ) , \text{?} ( g , h ) ) ) / 18 \\ = 2 \cdot ( \text{?} ( inst , inst ) \cdot \text{?} ) \\ + \text{?} ( inst , inst ) \text{?} \\ + \text{?} ( inst , inst ) \text{?} \\ + \text{?} ( inst , inst ) \text{?} \\ + \text{?} ( {arg}_{1} , {arg}_{1} ) \cdot \text{?} \\ + \text{?} ( {arg}_{1} , {arg}_{1} ) \cdot \text{?} / 18 \\ = 2 \cdot ( \text{?} ( run , ) \\ + \text{?} ( dog , ) \\ + \text{?} ( hat , ) \\ + \text{?} ( wear , ) \\ + \text{?} ( run , ) \cdot \text{?} ( dog , ) \\ + \text{?} ( dog , ) \cdot \text{?} ( hat , ) / 18\end{matrix} \\ here , if \text{?} ( run , ) = 1 , \text{?} ( dog , ) = 0.9 , \\ \text{?} ( hat , ) = 1 , \text{?} ( wear , ) = 0 & ( 15 )\end{matrix}$$

$${σ}_{align} ( {A}_{n} ) = 2 ( 1 + 0.9 + 1 + 0 + 0.9 + 0.9 ) / 18 = 0.522 \qquad ( 16 )$$

$$\text{?} \text{indicates text missing or illegible when filed}$$

The semantic tuple alignment unit 106 gives a maximum alignment score as a result of calculating the degree of similarity between the input sentences S₁ and S₂. Further, the semantic tuple alignment unit 106 gives the optimal alignment of the semantic tuples indicated by the alignment row with the highest alignment score and the degree of similarity between the semantic tuples aligned in the process of calculating the maximum alignment score as the alignment results of the semantic tuples. The semantic tuple alignment unit 106 passes the calculation result of the degree of similarity and the alignment results to the result output unit 107.

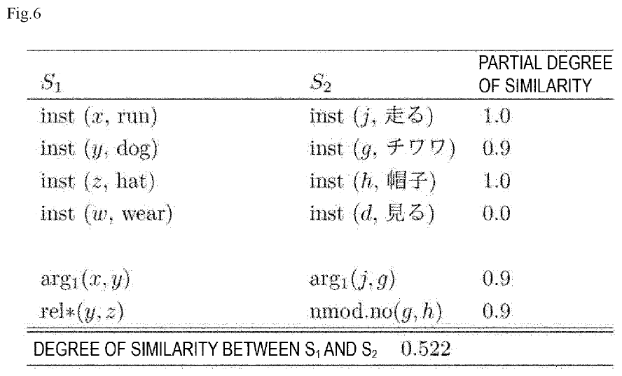

The result output unit 107 outputs the alignment results of the semantic tuples and the calculation result of the degree of similarity passed from the semantic tuple alignment unit 106. FIG. 6 illustrates an example of results output by the result output unit 107. In the example of FIG. 6, the overall degree of similarity “0.522” between the input sentences S₁ and S₂ is indicated, while degrees of similarity between aligned semantic tuples (“partial degree of similarity” in FIG. 6) are indicated as the alignment results of the semantic tuples. In this way, the alignment results of the semantic tuples are also indicated, so that information of matched or similar parts in the partial structures of the semantic representations can also be understood.

Next, effects of the sentence comparison apparatus 10 will be described.

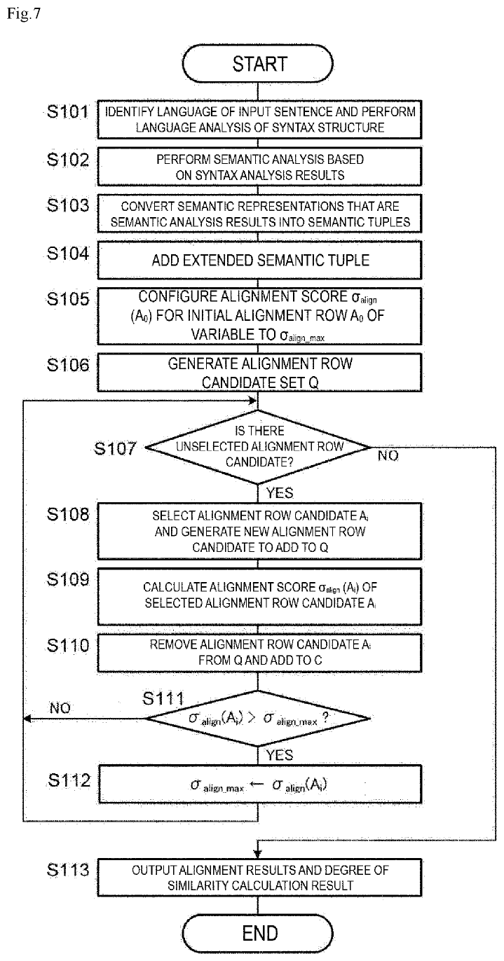

FIG. 7 is a flowchart illustrating a sequence of the sentence comparison processing performed by the sentence comparison apparatus 10. The CPU 11 reads the sentence comparison program from the ROM 12 or the storage 14, loads the sentence comparison program into the RAM 13, and executes the sentence comparison program, whereby the sentence comparison processing is performed.

At step S101, the CPU 11, as the language identification unit 101, receives the input sentences input to the sentence comparison apparatus 10, and identifies the types of languages described in accordance with the types of languages identified for each of the received input sentences. Then, the CPU 11, as the multilingual language analysis unit 102, performs linguistic analysis such as syntax analysis on each of the received input sentences by using the language analysis models 201A and 201B and passes the syntax analysis results to the multilingual semantic analysis unit 103.

Next, at step S102, the CPU 11, as the multilingual semantic analysis unit 103, receives the syntax analysis results from the multilingual language analysis unit 102, analyzes the semantic structures of the input sentences by using the semantic analysis models 202A and 202B in accordance with the types of the languages identified, and passes the semantic analysis results converted from the syntax analysis results into semantic representations to the multilingual semantic representation comparison unit 104.

Next, at step S103, the CPU 11, as the semantic tuple conversion unit 105, converts the semantic representations that are the semantic analysis results received from the multilingual semantic analysis unit 103 into semantic tuples including “rel (variable₁, variable₂)”, and “inst (variable, concept)”.

Next, at step S104, the CPU 11, as the semantic tuple conversion unit 105, creates and adds a new semantic tuple (extended semantic tuple) by combining semantic tuples having a common label (excluding subscripts) and a common variable in the first term.

Next, at step S105, the CPU 11, as the semantic tuple alignment unit 106, configures an initial alignment row A₀ between the sets of variables extracted by the semantic tuple conversion unit 105. Then, the semantic tuple alignment unit 106 calculates the alignment score σ_{align} (A₀) for the initial alignment row A₀, for example, according to Equations (6) to (11), and configures the alignment score as σ_{align_max}.

Next, at step S106, the CPU 11, as the semantic tuple alignment unit 106, generates the alignment row candidate set Q by either associating one variable with other variables or replacing the association between two alignments, from the initial alignment row A₀. Further, the CPU 11, as the semantic tuple alignment unit 106, prepares the alignment row candidate set C for which the alignment scores have been calculated as an empty set.

Next, at step S107, the CPU 11, as the semantic tuple alignment unit 106, determines whether there is an unselected alignment row candidate in the alignment row candidate set Q. In a case that there is an unselected alignment row candidate, the processing proceeds to step S108, and in a case that there is no unselected alignment row candidate, the processing proceeds to step S113.

At step S108, the CPU 11, as the semantic tuple alignment unit 106, selects one of the unselected alignment row candidates Aᵢ from the alignment row candidate set Q, generates an alignment row candidate adjacent to Aᵢ for the selected alignment row candidate Aᵢ, and adds the alignment row candidate to the alignment row candidate set Q. The generation of the alignment row candidate adjacent to Aᵢ is performed in a manner similar to that performed for the initial alignment row A₀ at step S106 described above. However, the alignment row candidates already included in the alignment row candidate sets Q and C are not added to the alignment row candidate set Q.

Next, at step S109, the CPU 11, as the semantic tuple alignment unit 106, calculates the alignment score σ_{align} (Aᵢ) for the selected alignment row candidate Aᵢ.

Next, at step S110, the CPU 11, as the semantic tuple alignment unit 106, removes the selected alignment row candidate Aᵢ from the alignment row candidate set Q and adds the selected alignment row candidate to the calculated alignment row candidate set C.

Next, at step S111, the CPU 11, as the semantic tuple alignment unit 106, determines whether the alignment score σ_{align} (Aᵢ) calculated at step S109 described above is greater than σ_{align_max}. In a case of σ_{align} (Aᵢ)>σ_{align_max}, the processing proceeds to step S112, and in a case of σ_{align} (Aᵢ) σ_{align_max}, the processing returns to step S107.

At step S112, the CPU 11, as the semantic tuple alignment unit 106, configures the alignment score σ_{align} (Aᵢ) calculated at step S109 described above to σ_{align_max}, and the processing returns to step S107.

At step S113, the CPU 11, as the semantic tuple alignment unit 106, gives the maximum alignment score σ_{align} (A_{M}) that is currently configured to σ_{align_max} as the calculation result of the degree of similarity between the input sentences S₁ and S₂. The CPU 11, as the semantic tuple alignment unit 106, gives the optimal alignment of the semantic tuples indicated by the alignment row A_{M} with the highest alignment score and the degree of similarity between the semantic tuples aligned in the process of calculating the maximum alignment score as the alignment results of the semantic tuples. Then, the CPU 11, as the semantic tuple alignment unit 106, passes the alignment results of the semantic tuples and the calculation result of the degree of similarity to the result output unit 107 and the result output unit 107 outputs the results, and the sentence comparison processing is terminated.

As described above, according to the sentence comparison apparatus according to the present embodiment, the degree of similarity between input sentences is calculated by performing semantic analysis of multilingual input sentences (text data) described in multiple languages to be compared, and performing comparison between the semantic representations. Accordingly, input sentences can be appropriately compared to each other based on the degree of similarity calculated by capturing the semantic contents of the representation of the input sentences, rather than the degree of similarity based on simple similarities of words or word sequences.

In the embodiment described above, the degree of similarity between the semantic tuples converted from the semantic representations is obtained, so that not only the degree of similarity of the whole input sentences, but also the match or similarity of the partial structures of the semantic representations can be understood.

In the embodiments described above, the semantic representations are converted into semantic tuples in a form of “rel (variable₁, variable₂)” and “inst (variable, concept)”, and further a new semantic tuple is added as an extended semantic tuple by combining semantic tuples having a common label (excluding subscripts) and a common variable in the first term. In a case that such extension of semantic representations is not performed, semantic representations obtained by means of semantic analysis (reference literatures 9 and 10) are compared and the degree of similarity between input sentences is calculated (reference literatures 11 and 12). In this case, the relationship via the content word and the relationship via the adjunct may not be flexibly associated with each other.

For example, in the input sentence S₁, two relationships (semantic tuples) are obtained via the content word “wear” including arg₁ (wear, dog) and arg₂ (wear, hat), but from the input sentence S₂, a relationship via the adjunct of nmod.with ( [symbol] , [symbol] ) is obtained, and the two cannot be properly associated with each other.

In the present embodiment, as described above, by adding the extended semantic tuples, the association of the semantic representations can be performed flexibly, so the appropriate degree of similarity can be calculated while capturing the semantic contents.

Reference literature 9: Laura Banarescu, Claire Bonial, Shu Cai, Madalina Georgescu, Kira Griffin, Ulf Hermjakob, Kevin Knight, Philipp Koehn, Martha Palmer and Nathan Schneider: Abstract Meaning Representation for Sembanking, In Proceedings of the Linguistic Annotation Workshop, (2013).
Reference literature 10: Sebastian Schuster, Ranjay Krishna, Angel Chang, Li Fei-Fei and Christopher D. Manning: Generating Semantically Precise Scene Graphs from Textual Descriptions for Improved Image Retrieval, In Proceedings of the Workshop on Vision and Language (VL15), (2015).
Reference literature 11: Shu Cai and Kevin Knight: Smatch: An Evaluation Metric for Semantic Feature Structures, In Proceedings of the 51st Annual Meeting of the Association for Computational Linguistics, ACL 2013, (2013).
Reference literature 12: Peter Anderson, Basura Fernando, Mark Johnson and Stephen Gould: SPICE: Semantic Propositional Image Caption Evaluation, In Proceedings of the 14th European Conference on Computer Vision, ECCV 2016, (2016).

Note that in the embodiments described above, when the degree of similarity between semantic tuples is calculated, the case where the degree of similarity is calculated with the same weight regardless of the relationship (arg₁) between the agent and the predicate or the modification relationship (nmod) between nouns has been described. However, the weight may be changed depending on the relation of the semantic tuples by changing simᵣₑₗ (r₁, r₂).

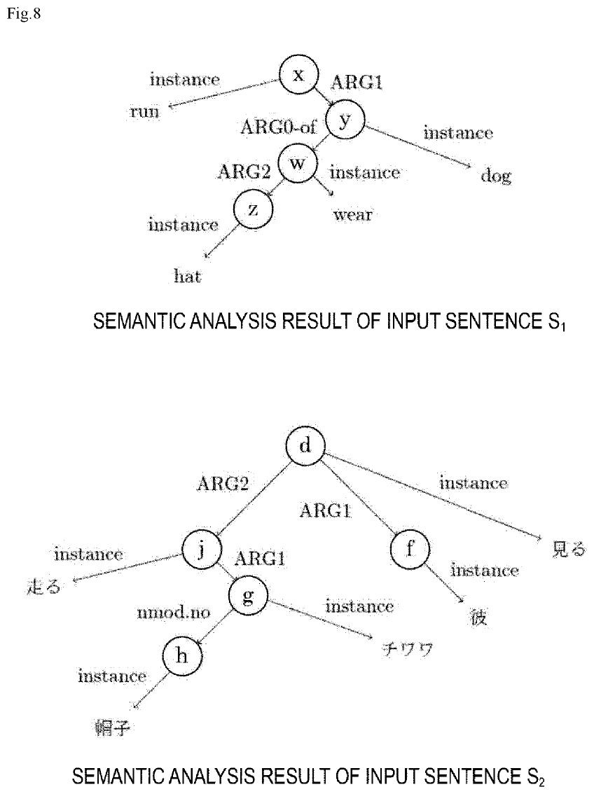

In the embodiments described above, semantic representations of the logical format type of UDepLambda have been used, but semantic representations of other logical format types such as Abstract Meaning Representation (AMR) or semantic graph type semantic representations may be used. FIG. 8 illustrates an example in which the same two sentences as the input sentences S₁ and S₂ used in the embodiments described above are analyzed by means of semantic graph type semantic analysis. Each node of the semantic graph corresponds to a variable of the logical formant type semantic representations illustrated in FIG. 4 and, in the example of FIG. 8, a variable corresponding to the node is exhibited within the node. An edge that connects the nodes is provided with a label indicating the relationship between the variables corresponding to the nodes at both ends of the edge. A concept corresponding to a variable indicated by each node is connected to the node as a leaf node. By performing the same procedure as in the embodiments described above by using the variables corresponding to respective nodes, the labels applied to the edges, and the concepts indicated by the leaf nodes, it is possible to extract the same semantic tuples as in FIG. 5. After the extraction of the semantic tuples, it is possible to perform the alignment and the degree of similarity calculation of the semantic tuples in a similar manner to the case of the logical format type semantic representations of the embodiments described above.

Note that, in each of the above-described embodiments, various processors other than the CPU may execute the sentence comparison processing that the CPU executes by reading software (program). Examples of the processor in such a case include a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like. The sentence comparison processing may be executed by one of such various processors or may be executed by a combination of two or more processors of the same type or different types (for example, multiple FPGAs, a combination of a CPU and an FPGA, or the like). More specifically, the hardware structure of such various processors is an electrical circuit obtained by combining circuit devices such as semiconductor devices.

In each of the embodiments described above, although a form in which the sentence comparison processing program is stored (installed) in the ROM 12 or the storage 14 in advance has been described, the form is not limited thereto. The program may be provided in the form of being stored in a non-transitory storage medium such as a compact disc read only memory (CD-ROM), a digital versatile disc read only memory (DVD-ROM), or a universal serial bus (USB) memory. The program may be in a form that is downloaded from an external device via a network.

With respect to the above embodiment, the following supplements are further disclosed.

### Supplementary Note 1

A sentence comparison apparatus including
a memory and
at least one processor coupled to the memory,
in which the processor is configured to
receive analysis results of semantic structures in which a semantic structure of each of multiple input sentences is analyzed in accordance with types of languages of the input sentences, based on syntax structures in which each of the multiple input sentences described in different languages is analyzed in accordance with the types of the languages of the input sentences, which are described in natural language, and compare the input sentences to each other to calculate a degree of similarity between the input sentences, based on the analysis results.

### Supplementary Note 2

A non-transitory recording medium storing a program executable by a computer to perform sentence comparison processing,
in which the sentence comparison processing includes
receiving analysis results of semantic structures in which a semantic structure of each of multiple input sentences is analyzed in accordance with types of languages of the input sentences, based on syntax structures in which each of the multiple input sentences described in different languages is analyzed in accordance with the types of the languages of the input sentences, which are described in natural language, and comparing the input sentences to each other to calculate a degree of similarity between the input sentences, based on the analysis results.

### REFERENCE SIGNS LIST

10 Sentence comparison apparatus

11 CPU

12 ROM

13 RAM

14 Storage

15 Input unit

16 Display unit

17 Communication I/F

19 Bus

101 Language identification unit

102 Multilingual language analysis unit

103 Multilingual semantic analysis unit

104 Multilingual semantic representation comparison unit

105 Semantic tuple conversion unit

106 Semantic tuple alignment unit

107 Result output unit

201A, 201B Language analysis model

202A, 202B Semantic analysis model

203 Inter-concept similarity calculation model

204 Translation-pair dictionary

205 Multilingual thesaurus

206 Word distributed representation DB

1. A sentence comparison apparatus comprising circuit configured to execute a method comprising:
analyzing, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences; and
comparing the input sentences to each other to calculate a degree of similarity between the input sentences based on an analysis result of the semantic structure.

2. The sentence comparison apparatus according to claim 1, the circuit further configured to execute a method comprising:
analyzing the semantic structure of each of the plurality of input sentences by logical format type semantic representations representing a semantic structure of a sentence by a logical formula.

3. The sentence comparison apparatus according to claim 1, the circuit further configured to execute a method comprising:
analyzing the semantic structure of each of the plurality of input sentences by a semantic graph that connects nodes corresponding to concepts contained in a sentence with edges based on a semantic relationship between the nodes.

4. The sentence comparison apparatus according to claim 1, the circuit further configured to execute a method comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

5. The sentence comparison apparatus according to claim 4, the circuit further configured to execute a method comprising:
adding, among semantic tuples that indicate the relationships between the variables, based on the relationships between the variables and the semantic tuples whose one of the variables is common, an extended semantic tuple combining another one of the variables included in the semantic tuples.

6. A computer-implemented method for comparing sentences, comprising:
analyzing, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences; and
comparing, the input sentences to each other to calculate a degree of similarity between the input sentences based on an analysis result of the semantic structure.

7. A computer-readable non-transitory recording medium storing computer-executable program instructions that when executed by a processor cause a computer system to execute a method comprising:
analyzing, based on an analysis result in which respective grammatical syntax structures of a plurality of input sentences described in two or more languages are analyzed in accordance with language types of input sentences, the input sentences being described in a natural language, a semantic structure of each of the plurality of input sentences in accordance with the language types of the input sentences; and
comparing the input sentences to each other to calculate a degree of similarity between the input sentences based on an analysis result of the semantic structure.

8. The sentence comparison apparatus according to claim 2,
the circuit further configured to execute a method comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

9. The sentence comparison apparatus according to claim 3,
the circuit further configured to execute a method comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

10. The computer-implemented method according to claim 6, further comprising:
analyzing the semantic structure of each of the plurality of input sentences by logical format type semantic representations representing a semantic structure of a sentence by a logical formula.

11. The computer-implemented method according to claim 6, further comprising:
analyzing the semantic structure of each of the plurality of input sentences by a semantic graph that connects nodes corresponding to concepts contained in a sentence with edges based on a semantic relationship between the nodes.

12. The computer-implemented method according to claim 6, further comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

13. The computer-readable non-transitory recording medium according to claim 7, the computer-executable program instructions when executed further causing the computer system to execute a method comprising:
analyzing the semantic structure of each of the plurality of input sentences by logical format type semantic representations representing a semantic structure of a sentence by a logical formula.

14. The computer-readable non-transitory recording medium according to claim 7, the computer-executable program instructions when executed further causing the computer system to execute a method comprising:
analyzing the semantic structure of each of the plurality of input sentences by a semantic graph that connects nodes corresponding to concepts contained in a sentence with edges based on a semantic relationship between the nodes.

15. The computer-readable non-transitory recording medium according to claim 7, the computer-executable program instructions when executed further causing the computer system to execute a method comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

16. The computer-implemented method according to claim 10, further comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

17. The computer-implemented method according to claim 11, further comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

18. The computer-implemented method according to claim 12, further comprising:
adding, among semantic tuples that indicate the relationships between the variables, based on the relationships between the variables and the semantic tuples whose one of the variables is common, an extended semantic tuple combining another one of the variables included in the semantic tuples.

19. The computer-readable non-transitory recording medium according to claim 13, the computer-executable program instructions when executed further causing the computer system to execute a method comprising:
converting the analysis result of the semantic structure into semantic tuples that indicate relationships between variables corresponding to concepts included in the input sentences and the concepts, and semantic tuples that indicate relationships between the variables; and
associating the semantic tuples converted with each other between the input sentences.

20. The computer-readable non-transitory recording medium according to claim 15, the computer-executable program instructions when executed further causing the computer system to execute a method comprising:
adding, among semantic tuples that indicate the relationships between the variables, based on the relationships between the variables and the semantic tuples whose one of the variables is common, an extended semantic tuple combining another one of the variables included in the semantic tuples.
